(19) United States
(12) Patent Application Publication
(10) Pub. No.: US 2005/0062347 A1
(43) Pub. Date: Mar. 24, 2005

(54) System for integrating linear motion guide and reluctance-type linear motor

(75) Inventors: Do Hyun Kang, Changwon-si (KR); Jong Bo Ahn, Changwon-si (KR); Ji Won Kim, Boosan-si (KR); Jung Hwan Chang, Changwon-si (KR)

Correspondence Address: ROTHWELL, FIGG, ERNST & MANBECK, P.C., 1425 K STREET, N.W., SUITE 800, WASHINGTON, DC, 20005, US

(73) Assignee: Korea Electrotechnology Research Institute, Changwon (KR)

(21) Appl. No.: 10/944,417

(22) Filed: Sep. 20, 2004

(30) Foreign Application Priority Data
Sep. 20, 2003 (KR) 10-2003-0065418
Jun. 10, 2004 (KR) 10-2004-0042443

(51) Int. Cl. H02K 41/00

(52) U.S. Cl. 310/12

(57) ABSTRACT

The present invention provides a system for integrating a linear motion guide and a reluctance-type linear motor that can commonly employ a stationary member between the reluctance-type linear motor and the linear motion guide while removing a complicated connection structure between a conventional linear motion guide and a conventional linear motor for obtaining linear motion. In the system, a stationary unit interconnects a stationary member of the linear motion guide and a stationary member of the reluctance-type linear motor, and a movable unit interconnects a movable member of the linear motion guide and at least one movable member of the reluctance-type linear motor. Therefore, a structure of a linear transport device requiring both the linear motor and the linear motion guide is simplified, and cost is reduced.

### BACKGROUND OF THE INVENTION

1. Field of the Invention

The present invention relates to a system for integrating a linear motion guide with a reluctance-type linear motor so that a linear motion generation device can be simplified.

2. Description of the Related Art

As a means for obtaining power for straight-line motion of a linear transport device, a hydraulic or pneumatic system or a power transmission system such as a rotated motor or etc. is used, as is well known. However, these systems have a disadvantage in that system structure is complicated and also system manufacturing and maintenance costs are high.

To address the above-described disadvantage, a linear transport device adopting a linear motor has been recently developed. The linear motor directly causes straight-line motion, so the linear motor need not a power transmission system and the structure of the linear motor is simple. The linear motor applied to the linear transport device is disposed independently of a linear motion guide that guides linear transport.

However, because the linear motor and the linear motion guide must be independently disposed to perform the linear transport in the conventional linear transport device adopting the linear motor, there is a problem in that the structure of the conventional linear transport device is complicated and device manufacturing and maintenance costs are high.

### SUMMARY OF THE INVENTION

Therefore, the present invention has been made in view of the above and other problems, and it is an object of the present invention to provide a system for integrating a linear motion guide and a reluctance-type linear motor that can commonly employ a stationary member between the linear motion guide and the reluctance-type linear motor so that a complicated connection structure between the linear motion guide and the linear motor for obtaining a linear motion can be removed.

In accordance with an aspect of the present invention, the above and other objects can be accomplished by the provision of a system for integrating a linear motion guide and a reluctance-type linear motor, comprising: a stationary unit for interconnecting a stationary member of the linear motion guide and a stationary member of the reluctance-type linear motor; and a movable unit for interconnecting a movable member of the linear motion guide and at least one movable member of the reluctance-type linear motor. Here, the at least one movable member for the reluctance-type linear motor is connected to the moveable member for the linear motion guide by means of a support.

In accordance with one embodiment, the stationary member for the reluctance-type linear motor has a structure in which nonmagnetic materials are periodically inserted into a core of the stationary member so that a difference in magnetic resistances can be generated. N movable members for the reluctance-type linear motor at N phases include a core and a coil wound around the core, respectively. The movable members are disposed in a predetermined interval corresponding to an interval in which the nonmagnetic materials are inserted. Furthermore, the N movable members are sequentially excited so that thrust forces of all the movable members, each of which is created in a direction in which magnetic resistance between the core of the movable member and the core of the stationary member corresponding thereto is to be reduced, are generated in the same direction.

In accordance with another embodiment, N movable members for the reluctance-type linear motor at N phases include a core on which divided teeth are formed and a coil wound around the core, respectively. The stationary member for the reluctance-type linear motor has a structure in which divided teeth corresponding to the divided teeth formed on the core of the movable member are repeatedly formed on a core of the stationary member. The movable members are disposed in a predetermined interval corresponding to an interval of the divided teeth. And, nonmagnetic materials can be inserted between the divided teeth repeatedly formed on the core of the stationary member. The N movable members are sequentially excited so that thrust forces of all the movable members, each of which is created in a direction in which magnetic resistance between the teeth protruded on the core of the movable member and the teeth protruded on the core of the stationary member corresponding thereto is to be reduced, are generated in the same direction

The N movable members for the N-phase reluctance-type linear motor are disposed in a line in a movement direction. Alternatively, at least one of the N movable members for the N-phase reluctance-type linear motor is disposed in a line with another movable member in a direction perpendicular to a movement direction.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a system for integrating a linear motion guide and a reluctance-type linear motor in accordance with one embodiment of the present invention;

FIG. 2 is a side view illustrating the system in accordance with the embodiment of the present invention;

FIG. 3 shows a connection relation between a core and coil of a moveable member for the reluctance-type linear motor in the system in accordance with the embodiment of the present invention;

FIG. 4 is an explanatory view illustrating a principle of generating thrust force in the system in accordance with the embodiment of the present invention;

FIG. 5 is a circuit diagram illustrating a power supply circuit in the system in accordance with the embodiment of the present invention;

FIG. 6 is an exemplary waveform diagram illustrating exciting currents and thrust forces at respective phases and a combined thrust force versus a time of position in the system in accordance with the embodiment of the present invention;

FIG. 7 is a side view illustrating a system for integrating the linear motion guide and an N-phase reluctance-type linear motor in accordance with another embodiment of the present invention;

FIG. 8 is a circuit diagram illustrating a power supply circuit in the system for integrating the linear motion guide and the N-phase reluctance-type linear motor in accordance with another embodiment of the present invention;

FIG. 9 is an exemplary waveform diagram illustrating exiting currents and thrust forces at respective phases and a combined thrust force versus a time or position in the system for integrating the linear motion guide and the N-phase reluctance-type linear motor in accordance with another embodiment of the present invention;

FIG. 10 is a side view illustrating a state in which divided teeth formed on a core of a movable member and a core of a stationary member are disposed in the reluctance-type linear motor of FIG. 1 in accordance with another embodiment of the present invention;

FIG. 11 shows a connection relation between a core and coil of a moveable member for the reluctance-type linear motor in a system for integrating the reluctance-type linear motor and the linear motion guide having divided teeth formed on the core of the movable member and the core of the stationary member in accordance with another embodiment of the present invention;

FIG. 12 is an explanatory view illustrating a principle of generating thrust force in the system for integrating the reluctance-type linear motor and the linear motion guide having divided teeth formed on the core of the movable member and the core of the stationary member; and

FIG. 13 shows a state in which at least one movable member for the reluctance-type linear motor is disposed in a line with another movable member in a direction perpendicular to a movement direction.

### DETAILED DESCRIPTION OF PREFFERRED EMBODIMENTS

Now, preferred embodiments of the present invention will be described in detail with reference to the annexed drawings.

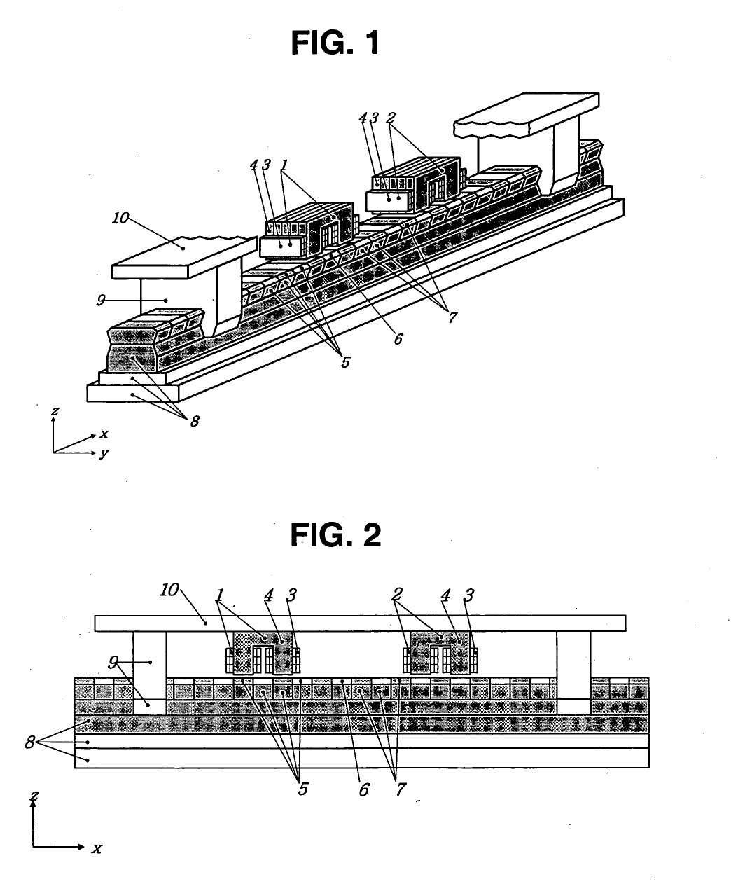

FIG. 1 is a perspective view illustrating a system for integrating a linear motion guide and a reluctance-type linear motor in accordance with one embodiment of the present invention; and FIG. 2 is a side view illustrating the system in accordance with the embodiment of the present invention.

As shown in FIGS. 1 and 2, the linear motor provided in the system in accordance with the embodiment of the present invention is a 2-phase reluctance-type linear motor. A movable unit of the motor includes a movable member 1 for an A-phase reluctance-type linear motor and a movable member 2 for a B-phase reluctance-type linear motor. Each of the movable members 1 and 2 includes a core 4 and a coil (winding) 3 wound around the core 4.

The movable member 1 for the A-phase reluctance-type linear motor and the movable member 2 for the B-phase reluctance-type linear motor are supported by a support 10 for the reluctance-type linear motor coupled to a movable member 9 for the linear motion guide, and are spaced by an interval τₚ to reduce ripples in the thrust force.

When electric current flows into the coil 3 of the movable member for the reluctance-type linear motor, the thrust force which makes magnetic resistance between the core 4 of the movable member 1 or 2 and a core 7 of a stationary member 5 become smaller is generated. Thus, in order for the thrust force to be generated more efficiently, nonmagnetic materials 6 is inserted into the core 7 of the stationary member 5 for the reluctance-type linear motor.

The linear motion guide includes a support 8 and the movable member 9. The stationary member 5 for the reluctance-type linear motor can be disposed on the upper part of the support 8 for the linear motion guide, such that the linear motion guide and the reluctance-type linear motor can be interconnected.

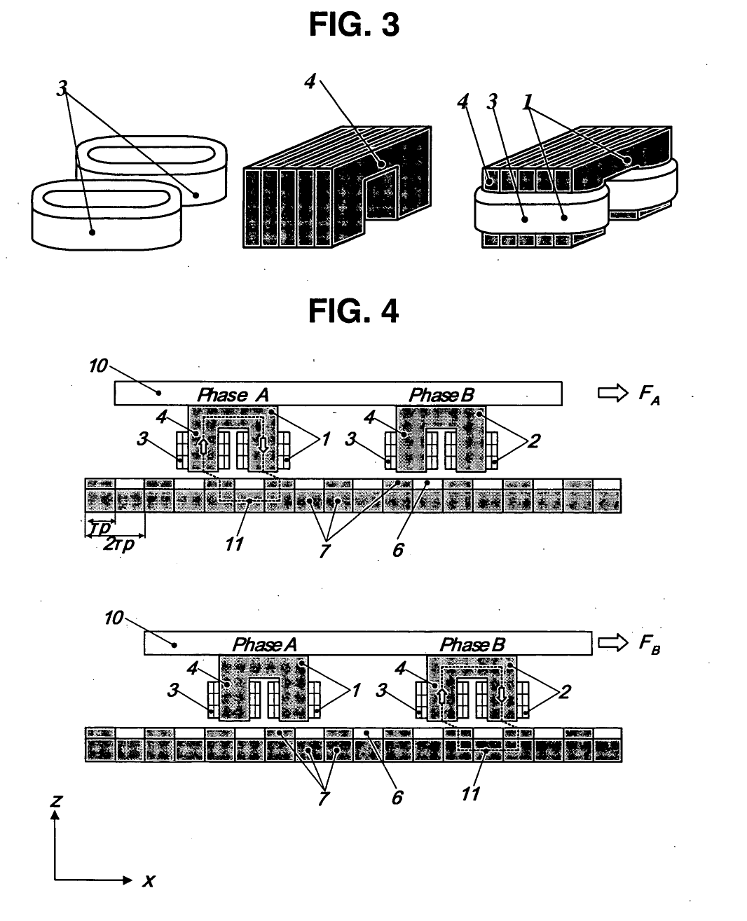

FIG. 3 shows a connection relation between the core and coil of the moveable member for the reluctance-type linear motor in the system in accordance with the embodiment of the present invention.

In accordance with the present invention, each of the movable members 1 and 2 includes the core 4 and the coil 3 thereof. When electric current flows into the coil 3 of the movable member 1 or 2, magnetic flux is generated at the core 4 of the movable member 1 or 2. At this point, the magnitude of the magnetic flux varies with that of the electric current, and core loss occurs at the core 4 of the movable member 1 or 2. In order to reduce the core loss, the core 4 of the movable member 1 or 2 may be a laminated core.

FIG. 4 is an explanatory view illustrating a principle of generating thrust force in the system in accordance with the embodiment of the present invention.

As shown in FIG. 4, the movable members 1 and 2 for the reluctance-type linear motor are configured such that when the movable members 1 and 2 are excited according to different positions thereof, thrust forces F_{A} and F_{B} are generated in the same direction. To reduce ripples in the thrust force, the movable members 1 and 2 are spaced by an interval τₚ.

When electric current flows into the coil 3 of the movable member 1 or 2, the magnetic flux 11 is generated at the core 4 of the movable member 1 or 2 as indicated by the dashed line in FIG. 4. There is a tendency for the magnetic flux to be aligned in a straight line in order to reduce magnetic resistance between the core 4 of the movable member and the core 7 of the stationary member. Accordingly the force making the magnetic flux aligned in a straight line shifts the movable member 1 for the reluctance-type linear motor to the right side, and reluctance is varied with the position of the movable member by the nonmagnetic materials 6 inserted into the core 7 of the stationary member.

Similarly, in order for the thrust force to be generated in the same direction, when the movable member is shifted by the interval τₚ, the electric current is applied to the movable member 2 for the B-phase reluctance-type linear motor and thus the thrust force is generated in the right direction.

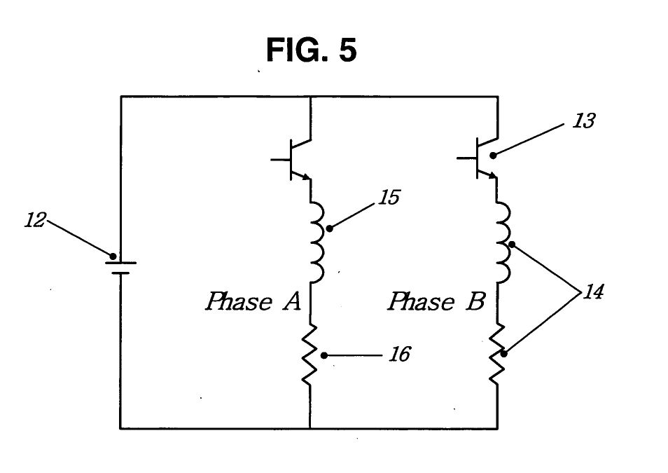

FIG. 5 is a circuit diagram illustrating a power supply circuit of the 2-phase reluctance-type linear motor in the system in accordance with the embodiment of the present invention.

As shown in FIG. 5, an equivalent circuit 14 of the reluctance-type linear motor comprises an inductor 15 and a resistor 16. A power supply 12 uses a direct current (DC) power supply. In the power supply circuit, a switch 13 at the A phase is turned on and an exciting current at the A phase is applied so that the thrust force FA at the A phase can be generated. Furthermore, another switch 13 at the B phase is turned on and an exciting current at the B phase is applied so that the thrust force F_{B} at the B phase can be generated.

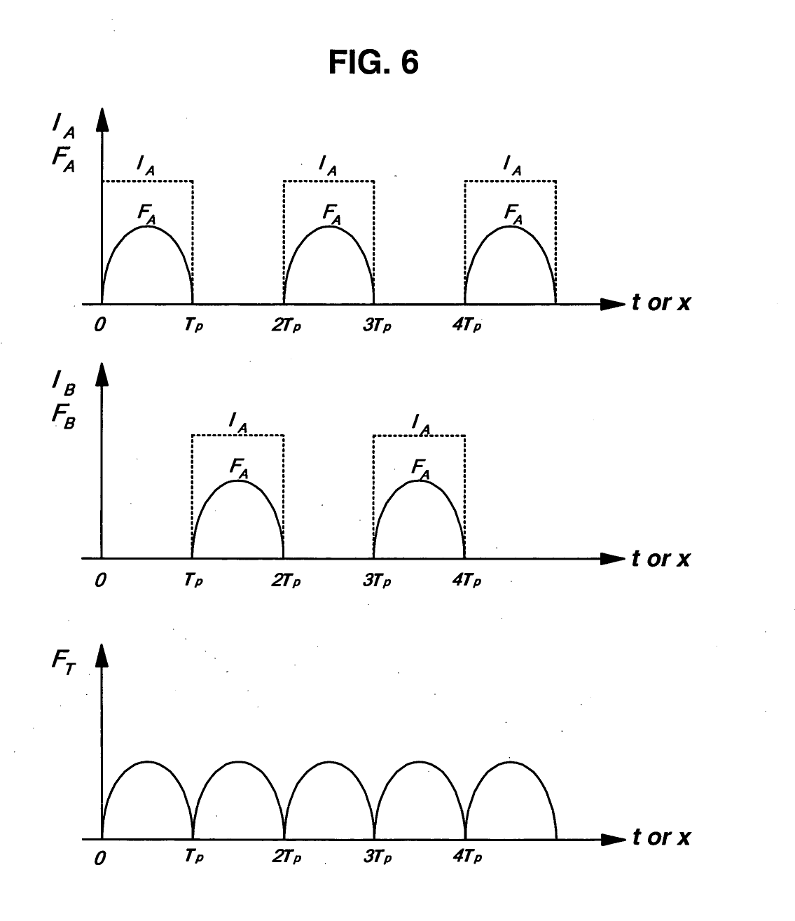

FIG. 6 is an exemplary waveform diagram illustrating exciting currents I_{A} and I_{B} and thrust forces F_{A} and F_{B} at two phases and a combined thrust force F_{T} versus a time t or position x in the system in accordance with the embodiment of the present invention. In order for the movable members 1 and 2 to be thrusted in one direction, the exciting current I_{A} at the A phase is applied in an interval between 0 and τₚ generating the thrust force F_{A}, and the exciting current I_{B} at the B phase is applied in an interval between τₚ and 2τₚ generating the thrust force F_{B}. The combined thrust force F_{T} is the sum of the thrust forces F_{A} and F_{B} generated by the exciting currents at the A and B phases.

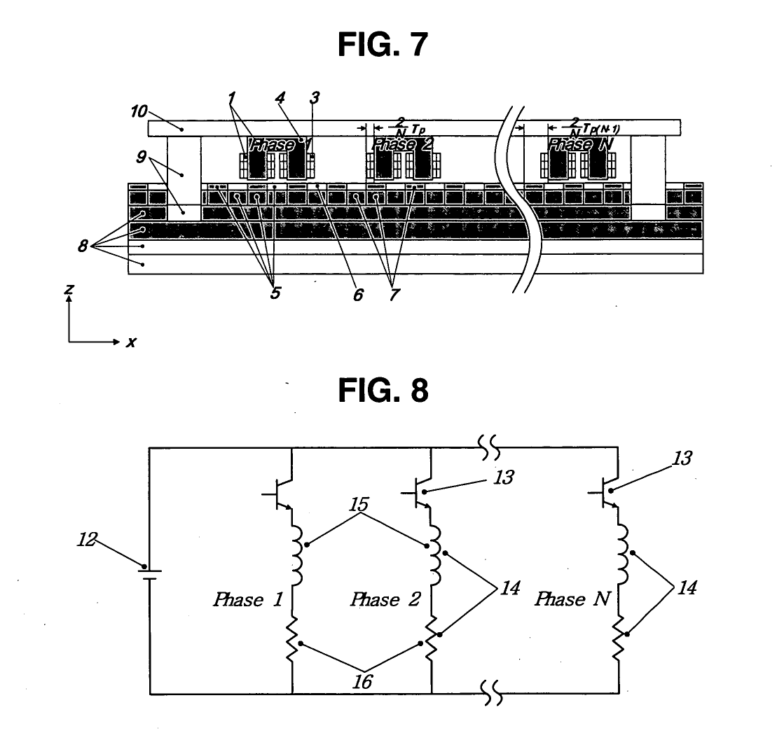

FIG. 7 is a side view illustrating a system for integrating the linear motion guide and an N-phase reluctance-type linear motor in accordance with another embodiment of the present invention.

As shown in FIG. 7, the reluctance-type linear motor can be configured at multiple phases equal to two or more phases so that a greater thrust force can be generated and simultaneously ripples in the thrust force can be reduced. For this, movable members for the reluctance-type linear motor are spaced by an interval 2π/N and disposed in a line along the stationary member 5 for the reluctance-type linear motor. A movable member at the last N-th phase is disposed in a position of 2τ(N−1)/N.

FIG. 8 is a circuit diagram illustrating a power supply circuit in the system for integrating the linear motion guide and the N-phase reluctance-type linear motor in accordance with another embodiment of the present invention. The power supply unit for the N-phase reluctance-type linear motor shown in FIG. 8 includes N number of equivalent circuits coupled in a parallel fashion that are equal to the equivalent circuit including the inductor and the resistor in the power supply unit of the 2-phase reluctance-type linear motor shown in FIG. 5, respectively.

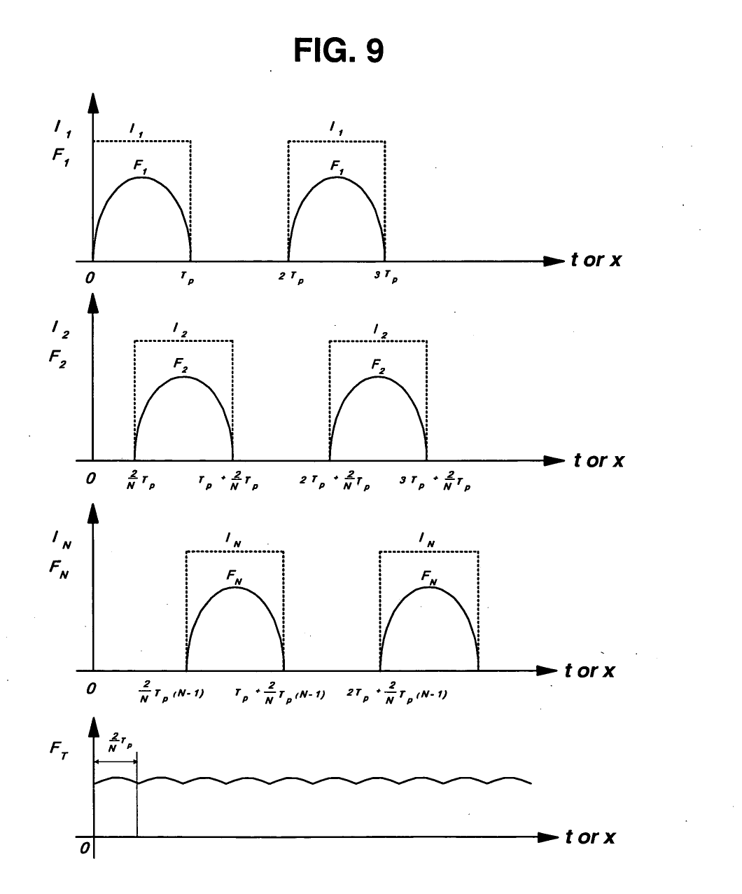

FIG. 9 is an exemplary waveform diagram illustrating exciting currents I₁, I₂, . . . , I_{N} and thrust forces F₁, F₂, . . . , F_{N} at N phases, and a combined thrust force F_{T} versus a time t or position x in the system for integrating the linear motion guide and the N-phase reluctance-type linear motor in accordance with another embodiment of the present invention.

In order for the movable members for the reluctance-type linear motor to be thrusted in one direction, the exciting current I₁ at a first phase is applied in an interval between 0 and τₚ generating the thrust force F₁, and the exciting current I₂ at a second phase is applied in an interval between 2τₚ/N and τₚ+τₚ/N generating the thrust force F₂. And, the exciting current I_{N} at the last phase is applied in an interval between 2τₚ(N−1)/N and τₚ+2τₚ(N−1)/N generating the thrust force F_{N}.

The combined thrust force F_{T} is the sum of the thrust forces F₁, F₂, . . . , F_{N} generated by the exciting currents sequentially applied in corresponding intervals.

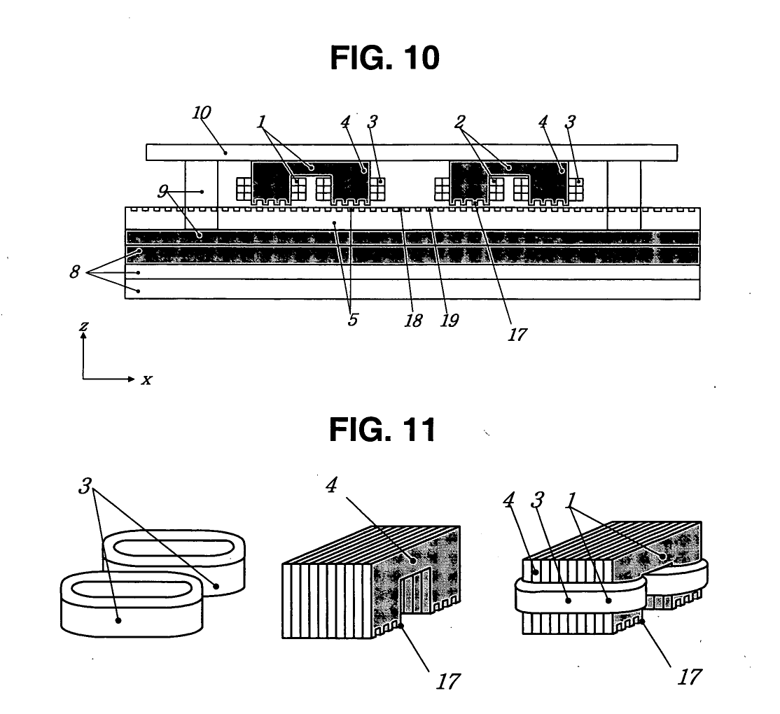

FIG. 10 is a side view illustrating a state in which divided teeth formed on a core of a movable member and a core of a stationary member have been disposed in the reluctance-type linear motor of FIG. 1 in accordance with another embodiment of the present invention. As shown in FIG. 10, divided teeth 17 are formed on the core 4 of the movable member for the reluctance-type linear motor, and divided teeth 18 corresponding to the divided teeth 17 formed on the core 4 of the movable member are periodically formed on the core of the stationary member for the reluctance-type linear motor. Thus, the movable member can be precisely and shortly shifted. Nonmagnetic materials 19 can be inserted between the divided teeth 18 of the core of the stationary member, such that different magnetic resistances are generated and dust is not accumulated.

FIG. 11 shows a connection relation between a core and coil of a moveable member for the reluctance-type linear motor in a system for integrating the reluctance-type linear motor and the linear motion guide having divided teeth formed on the core of the movable member and the core of the stationary member in accordance with another embodiment of the present invention. As shown in FIG. 11, the movable members 1 and 2 include a core 4 and a coil 3 for the reluctance-type linear motor, respectively. A plurality of divided teeth 17 are formed on the core 4 of the movable member for the reluctance-type linear motor.

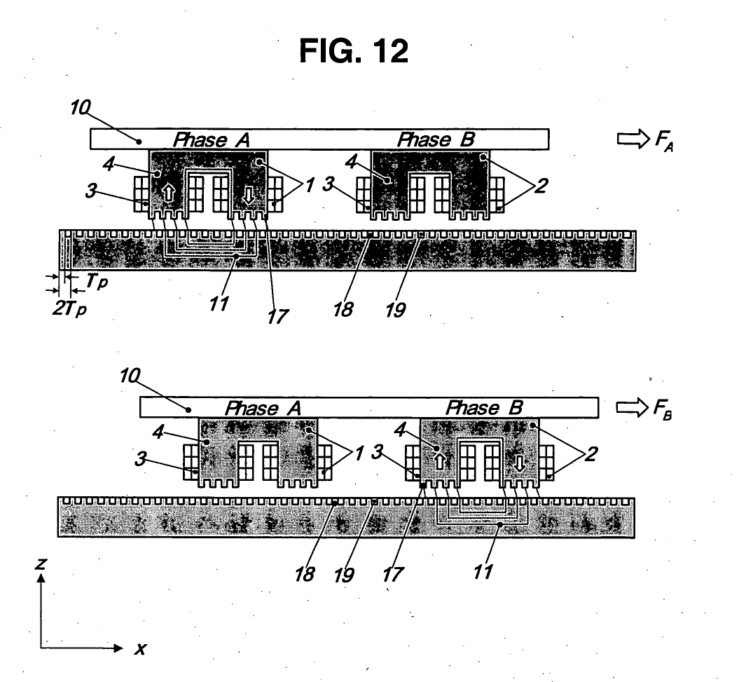

FIG. 12 is an explanatory view illustrating a principle of generating thrust force in the system for integrating the reluctance-type linear motor and the linear motion guide having divided teeth formed on the core of the movable member and the core of the stationary member. When electric current flows into the coil 3 of the movable member in a state in which divided teeth 17 and 18 are formed on the core 4 of the movable member and the core of the stationary member for the reluctance-type linear motor, magnetic flux 11 is generated between the small teeth 17 and 18 as indicated by the dashed line. The force making the magnetic flux aligned in a straight line shifts the movable member 1 for the A-phase reluctance-type linear motor by an interval τₚ of a small distance to the right side.

Similarly, when the movable member 1 for the A-phase reluctance-type linear motor has been shifted by the interval τₚ, electric current is applied to the movable member 2 for the B-phase reluctance-type linear motor. Magnetic flux 11 is generated between the small teeth 17 and 18 as indicated by the dashed line. The force making the magnetic flux aligned in a straight line shifts the movable member 2 for the B-phase reluctance-type linear motor by the interval τₚ in the right side.

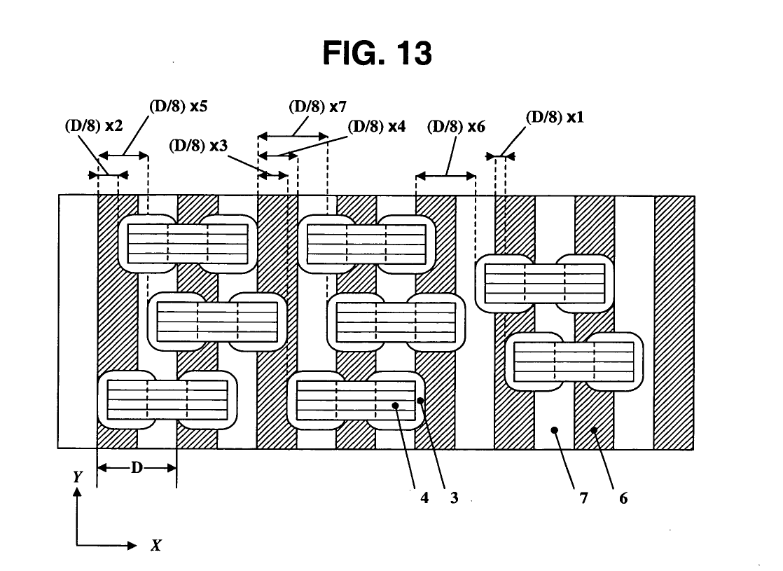

All the movable members for the reluctance-type linear motor are disposed in a line in a movement direction (i.e., an x direction in FIG. 1) as shown in FIGS. 1, 2, 4, 7, 10 and 12. Alternatively, at least one movable member for the reluctance-type linear motor can be disposed in a line with another movable member in a direction perpendicular to the movement direction (i.e., a y direction in FIG. 1) as shown in FIG. 13. Thus, spatial limitations can be overcome, and the structure of the linear transport device can be variously modified.

In accordance with the present invention, a system for integrating a linear motion guide and a reluctance-type linear motor can be applied to transport equipment necessary for manufacturing a semiconductor, a transport device requiring a small space and other linear transport systems.

As apparent from the above description, the present invention can simply implement a linear transport device requiring both a linear motor and a linear motion guide, reduce an installation space of the device, reduce device manufacturing and maintenance costs, and implement clean straight-line transport, by integrating a reluctance-type linear motor with the linear motion guide. In accordance with the present invention, a core and coil of a movable member are installed in a primary side of a short length, and a secondary side of a long length uses a stationary member of the linear motion guide, such that material costs can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A system for integrating a linear motion guide and a reluctance-type linear motor, comprising:
a stationary unit for interconnecting a stationary member of the linear motion guide and a stationary member of the reluctance-type linear motor; and
a movable unit for interconnecting a movable member of the linear motion guide and at least one movable member of the reluctance-type linear motor.

2. The system of claim 1, wherein the movable unit has a structure in which the at least one movable member for the reluctance-type linear motor is connected to the moveable member for the linear motion guide by means of a support.

3. The system of claim 2, wherein N movable members for the reluctance-type linear motor at N phases include a core and a coil wound around the core, respectively, and said N is equal to or more than two, and
wherein the stationary member for the reluctance-type linear motor has a structure in which nonmagnetic materials are periodically inserted into a core of the stationary member so that a difference in magnetic resistances can be generated.

4. The system of claim 3, wherein a residual value is any one of (D/N)*i (where i=1, 2, . . . , N−1) and residual values are different each other, when each distance of a component of a direction in which the N movable members move, in (N−1) distances between any one of the N movable members and the other (N−1) movable members for the reluctance-type linear motor, is divided by an interval D in which the nonmagnetic materials are periodically inserted into the core of the stationary member.

5. The system of claim 4, wherein the N movable members are sequentially excited so that thrust forces of all the movable members, each of which is created in a direction in which magnetic resistance between the core of the movable member and the core of the stationary member corresponding thereto is to be reduced, are generated in the same direction.

6. The system of claim 2, wherein N movable members for the reluctance-type linear motor at N phases include a core on which divided teeth are formed and a coil wound around the core, respectively, and said N is equal to or more than two, and
wherein the stationary member for the reluctance-type linear motor has a structure in which divided teeth corresponding to the divided teeth formed on the core of the movable member are repeatedly formed on a core of the stationary member.

7. The system of claim 6, which the stationary member for the reluctance-type linear motor has a structure in which nonmagnetic materials are inserted between the divided teeth repeatedly formed on the core of the stationary member.

8. The system of claim 6, wherein a residual value is any one of (D/N)*i (where i=1, 2, . . . , N−1) and residual values are different each other, when each distance of a component of a direction in which the N movable members move, in (N−1) distances between any one of the N movable members and the other (N−1) movable members for the reluctance-type linear motor, is divided by an interval D in which the divided teeth are repeatedly formed.

9. The system of claim 8, wherein the N movable members are sequentially excited so that thrust forces of all the movable members, each of which is created in a direction in which magnetic resistance between the teeth protruded on the core of the movable member and the teeth protruded on the core of the stationary member corresponding thereto is to be reduced, are generated in the same direction

10. The system of claim 4, wherein the N movable members for the N-phase reluctance-type linear motor are disposed in a line in a movement direction.

11. The system of claim 4, wherein at least one of the N movable members for the N-phase reluctance-type linear motor is disposed in a line with another movable member in a direction perpendicular to a movement direction.

12. The system of claim 3, wherein the core of the movable member for the reluctance-type linear motor is a laminated core.
